(19) United States
(12) Patent Application Publication
(10) Pub. No.: US 2007/0005645 A1
(43) Pub. Date: Jan. 4, 2007

(54) Printing system and method with local printer for locally searching, selecting and printing from remote database

(75) Inventors: Thomas Chase, Welwyn Garden City (GB); Tomas Bystrom, Highgate (GB); Dean Lynn, Herts (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/170,011

(22) Filed: Jun. 29, 2005

(51) Int. Cl. G06F 17/00

(52) U.S. Cl. 707/104.1

(57) ABSTRACT

A printing system for locally searching, selecting and printing one or more electronic documents on a local printer from a remote database includes a local printer having an input/output user interface that provides a search menu to a user, receives search parameters and a search request from the user, provides search results to the user, and receives a selection of one or more items from the search results. At least one remote network server having a database of electronic documents is linked to the local printer over a network. The local printer searches the database of electronic documents using the search parameters to generate the search results of one or more items. The selection is retrieved from the database and printed by the local printer.

### BACKGROUND

Exemplary embodiments discussed herein relate generally to a printing system and, more particularly, to a printing system and method employing a local printer for locally searching, selecting and printing from a remote database. These embodiments find particular application in a printing system employing an electrophotographic imaging machine as the local printer and will be described with particular reference thereto. It is to be appreciated, however, that the exemplary embodiments discussed herein are also amenable to other like applications.

In a typical printing system employing an electrophotographic imaging machine, such as an electrophotographic printer, a photoconductive insulating member is charged to a substantially uniform potential and thereafter exposed to a light image representative of a document to be produced. This exposure discharges the photoconductive insulating surface in exposed or background areas and creates an electrostatic latent image on the member, corresponding to image areas of the document to be produced. Subsequently, the electrostatic latent image on the photoconductive insulating surface is made visible by developing the image with developing powder referred to in the art as toner. This developed image may be subsequently transferred to a print medium, such as a sheet of copy paper, to which it may be permanently affixed by heating and/or by the application of pressure, i.e., fusing.

Currently, electronic documents, including e-books, are available for download to one's personal computer. Often, a personal computer communicates with an e-book or electronic document provider via the Internet. The provider can host an Internet website on a network server which can be accessed by the personal computer over the Internet. The website will provide a listing of electronic documents available and, optionally, prices for downloading each electronic document. If desired, the user can select one or more electronic documents for download, provide payment information and download the selections to the personal computer. The downloaded document can then be accessed through a software application for viewing by the user. If desired, the user can print the downloaded document to a physically separate printer linked to the personal computer. Sometimes the downloaded document is transferred to a portable viewing device so that the user can easily take the downloaded document to various locations.

### BRIEF DESCRIPTION

In one exemplary embodiment, a method is provided for locally searching for and printing an electronic document on a local printer. In the method, a search menu is provided on a local printer. Search parameters and a search request are received at the local printer from a user. A remote database of electronic documents is searched with the search parameters. Search results from the remote database are generated. The search results include one or more items corresponding to one or more of the electronic documents. The search results are provided on the local printer. A selection of the one or more items of the search results are received at the local printer from a user. The selection is printed on the local printer.

In another exemplary embodiment, a method is provided for locally searching, selecting and printing one or more electronic documents on a local printer from a remote database. In the method, search parameters are entered on a local printer. A search of a remote database of electronic documents is requested to be performed by the local printer employing the search parameters. The search results generated and displayed on the local printer are reviewed. The search results include one or more items corresponding to the electronic documents. One of the one or more items on the local printer is selected to be printed. Printed copies of the selected one of the one or more items printed by the local printer are retrieved from the local printer.

In yet another exemplary embodiment, a printing system is provided for locally searching, selecting and printing one or more electronic documents on a local printer from a remote database. The printer system includes a local printer having an input/output user interface that provides a search menu to a user, receives search parameters and a search request from the user, provides search results to the user, and receives a selection of one or more items from the search results. At least one remote network server having a database of electronic documents is linked to the local printer over a network. The local printer searches the database of electronic documents using the search parameters to generate the search results of one or more items. The selection is retrieved from the database and printed by the local printer.

### BRIEF DESCRIPTION OF THE DRAWINGS

FIG. 1 is a schematic view of a printing system including one or more remote network servers, each having a database of electronic documents, linked to a local printer through a network.

FIG. 2 is an enlarged schematic view of the local printer of FIG. 1.

FIG. 3 is a block diagram illustrating one method for locally searching, selecting and printing one or more electronic documents on the local printer of FIG. 1 from the remote database(s) of FIG. 1.

FIG. 4 is an exemplary e-book search menu for display on the local printer of FIG. 1.

FIG. 5 is a search results display for display on the local printer of FIG. 1.

### DETAILED DESCRIPTION

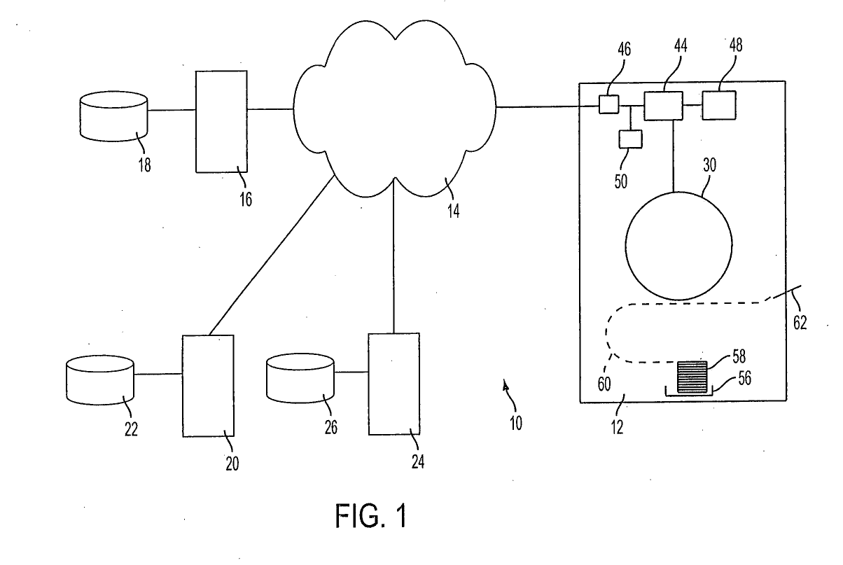

Referring now to the drawings wherein the showings are for purposes of illustrating one or more exemplary embodiments, a printing system 10 is schematically depicted in FIG. 1 for searching, selecting and printing one or more electronic documents on a local printer from a remote database. The illustrated system 10 includes a local printer 12 connected or linked to a network 14, such as the Internet, for example. Alternatively, the network 14 could be any type of network such as a proprietary network, a local intranet, a wireless network, a telephone network, etc. The system 10 further includes one or more remote network servers connected or linked to the network 14 and to the printer 12 through the network.

Each network server includes or is linked to a remote database which is configured to store, index and/or access electronic documents as will be described in more detail below. Although not illustrated, the database of any one of the one or more remote network servers can be a plurality of databases linked to one another, as could each of the one or more network servers be a plurality of servers configured to operate on a cooperative parallel basis. In the schematically illustrated embodiment, the one or more remote network servers include a first network server 16 having a first database 18, a second network server 20 having a second database 22 and a third network server 24 having a third database 26.

The word “printer” is used in connection with the one or more exemplary embodiments discussed herein to generally refer to or encompass any apparatus, such as a digital copier, bookmaking machine, facsimile machine, multi-function machine, etc. which performs a print outputting function for any purpose. The word “linked” is used in connection with the one or more exemplary embodiments discussed herein to generally refer to a wired or wireless link or other means capable of supplying or communicating electronic data to and/or from the connected/linked elements. For example, the links between elements can be telephone lines, computer cables, ISDN lines, wireless communication means or links (e.g., employing Bluetooth® wireless technology) and the like.

While the illustrated 'system 10 shows the printer 12 as an electrophotographic printer and particular reference herein is made to printer 12 including an electrophotographic marking engine, printer 12 can alternatively be an ink-jet printer, a solid ink printer, a thermal head printer used in conjunction with heat sensitive paper, or any other device capable of marking an image on a substrate. It is to be appreciated that such alternative marking machines can, like printer 12, include an input/output interface, a memory, a marking cartridge platform, a marking driver, a function switch, sensors, a controller and a self-diagnostic unit, all of which can be interconnected by a data/control bus. Additionally, it is to be appreciated that, though the printer 12 is schematically shown in a configuration which would employ only a single marking engine, alternate printers employable in the system 10 could include multiple marking engines and related components.

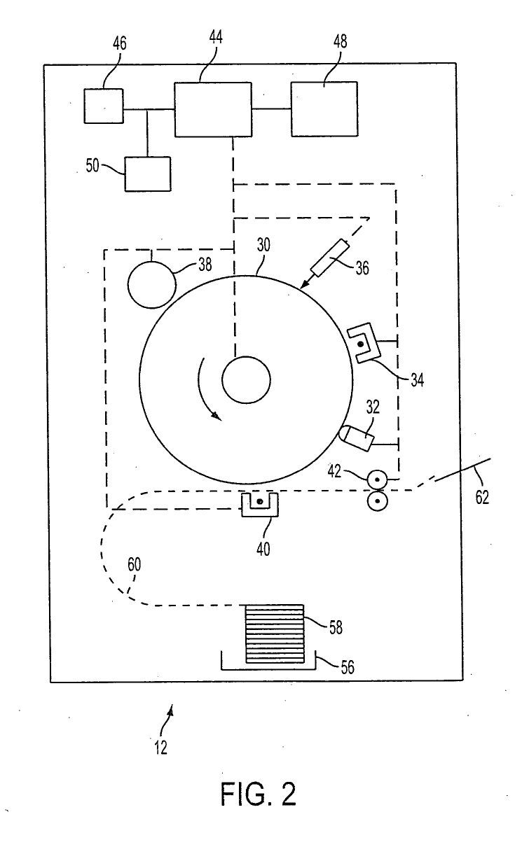

In the illustrated embodiment, the printer 12 of the printing system 10 can be a xerographic imaging machine. With additional reference to FIG. 2, the printer 12 of the illustrated embodiment includes many of the hardware elements or components employed in the creation of desired images by electrophotographical processes, as will be known and understood by those skilled in the art. In the illustrated embodiment, for example, the printer 12 includes a charge retentive surface member, such as rotating photoreceptor 30 in the form of a drum, for example (alternatively, the rotating photoreceptor could be a belt or other rotating device having a charge retentive surface).

As also known and understood by those skilled in the art, images can be created on the photoreceptor 30 and ultimately transferred from the photoreceptor 30 to print media, such as a sheet of paper. The term “print media” is used in connection with the one or more exemplary embodiments discussed herein to generally refer to a usually flimsy physical sheet of paper, plastic, or other suitable physical print media substrate for images, whether precut or web fed. Disposed about the photoreceptor 30 are various xerographic subsystems, including a cleaning device or station 32, a charging station 34, an exposure station 36, which forms a latent image on the photoreceptor 30, a developer 38 for developing the latent image by applying a toner thereto to form a toner image, a transferring unit, such as a transfer corotron 40, which transfers the toner image thus formed to the print media, and a fuser 42, which fuses the transferred image to the print media. In the illustrated embodiment, the fuser 42 is adapted to apply at least one of heat and pressure to the print media to physically and permanently attach the toner and optionally to provide a level of gloss to the printed media. In any particular embodiment of an electrophotographic marking machine usable in place of printer 12, there can be variations to that described above, such as, for example, additional corotrons, cleaning devices, or, in the case of a color printer, multiple developers.

The xerographic subsystems 30,32,34,36,38,40,42 of the illustrated embodiment are controlled by a marking engine controller 44, such as a CPU. Though the controller 44 of the illustrated embodiment is schematically shown as a single unit, it is to be appreciated that the controller can be distributed throughout the marking machine 12 and formed of multiple remotely positioned components. For example, actuators forming the controller 44 can be located in or on the xerographic subsystems and thus the controller is not necessarily physically removed from or separate from other elements of the marking machine 12. In the illustrated embodiment, the marking engine controller 44 is linked to an input/output device interface 46, an input/output user interface 48 and a memory 50, and may also be linked to other components known by those skilled in the art to be provided with a marking engine printer, such as, for example, a marking cartridge platform, a marking driver, a function switch, sensors (such as an “out of paper” indicator), a self-diagnostic unit, all of which can be interconnected by a data/control bus.

The schematically illustrated printer 12 further includes a print media tray 56 suitable for holding print media, such as a stack 58 of precut print media sheets. As is known and understood by those skilled in the art, print media sheets are fed, typically from the top of the stack 58, along sheet path 60 to the transfer station 40 for receiving the toner image, through the fuser 42 for having the toner image permanently attached thereto and ultimately to an output tray 62 for retrieval. Although not illustrated, it is to be appreciated that the printer 12 could be configured to employ duplex operations on a print media sheet, wherein the sheet could be inverted and then fed for recirculation back through the transfer station 40 and the fuser 42 for receiving and permanently fixing a side two image to the backside of that duplex sheet. It should also be appreciated that printer 12 need not be limited to a single print media tray, and could alternatively have no tray wherein the printer 12 could be fed by a separate feeder or the like, or could have two or more trays, such as trays for holding print media sheets of varying types (e.g., sizes, material, etc.).

As shown, the input/output device interface 46 enables the printer 12 to be linked or communicate with the network 14. The input/output user interface 48 enables a user to interact or communicate with the printer. Through the network 14 (such as where the network is the Internet) and the input/output user interface 48, the user of the printer 12 can communicate with the one or more network servers 18,22,24. The printer 12 can be a local printer and any number of the one or more network servers can be geographically remote (i.e., not at the same physical location) relative to the printer. In one embodiment, the input/output user interface 48 can be an interactive touch-screen, as will be known and understood by those skilled in the art, wherein output from the printer 12 is displayed on a screen and thereby communicated to the user. Input can be received from the user by the user touching various portions of the screen, such as in a specified sequence, thereby enabling communication from the user to the printer 12. Alternatively, the interface 48 could be a display screen and a separate keyboard or keypad.

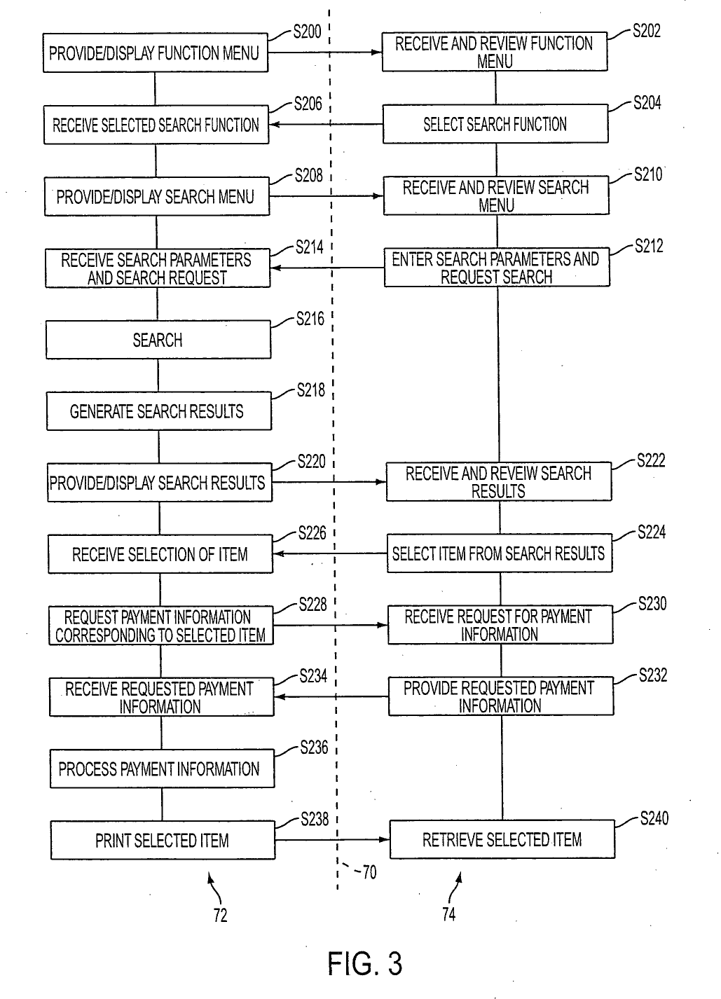

With additional reference to FIG. 3, one method for locally searching, selecting and printing one or more electronic documents on a local printer from a remote database will be described in connection with the printing system 10. In FIG. 3, steps performed by the printer 12 are shown on the left side of the dashed line 70 at 72 and steps performed or undertaken by the user of the printer 12 are shown on the right side of dashed line 70 at 74. In one embodiment, the local printer 12 provides a function menu to the user (S200). This can be accomplished by displaying the function menu on interactive touch screen 48 so that the user is able to receive and review the function menu (S202). The function menu (not illustrated) can be a menu of actions or services able to be performed by the printer 12. In one embodiment, the function menu includes an electronic document search function that can be selected by the user touching a section of the display 48 corresponding therewith (i.e., a button graphic can be displayed on the screen 48). Thus, when the user desires to search for an electronic document, the user can select the search function from the function menu (S204) by touching the appropriate location on the screen 48 and the printer 12 can thereby receive the selected search function from the user (S206).

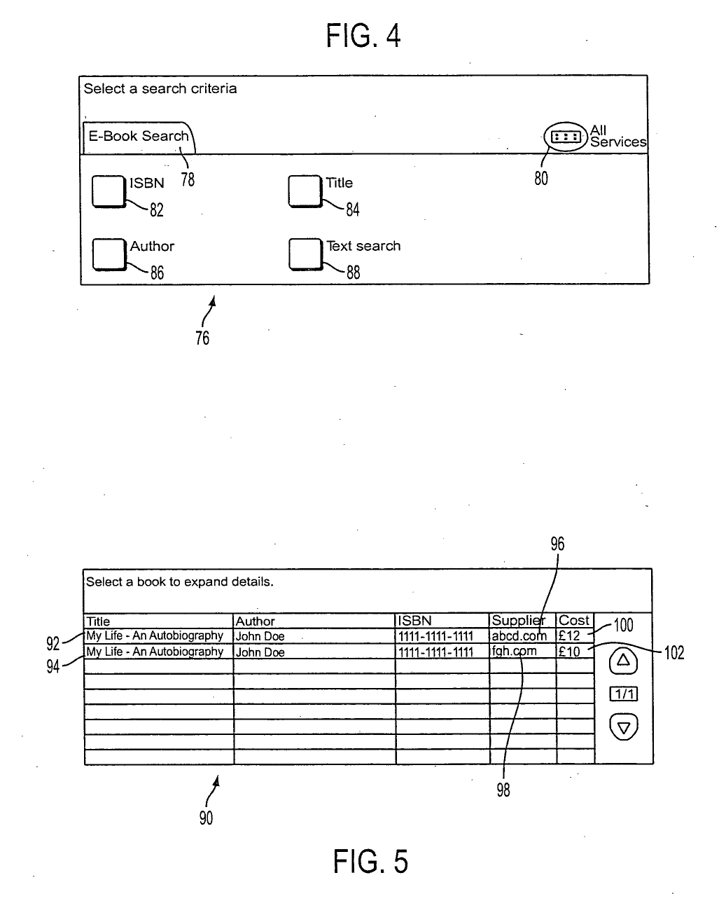

Upon receipt of the user's selection of the search function, the printer 12 can provide a search menu (S208), such as by displaying the search menu on the screen 48. In one embodiment, wherein the electronic documents to be searched are e-books, the search menu can be as illustrated in FIG. 4. Alternatively, the electronic documents to be searched could be electronic versions of newspapers, short stories, news items, etc. In FIG. 4, the illustrated search menu 76 includes a folder tab 78 indicating that the search function was selected. The search menu 76 additionally includes an all service icon 80 that, upon selection, can return the user to the function menu described above. In the illustrated search menu, several buttons are provided to the user, including ISBN button 82, title button 84, author button 86 and text search button 88, that correspond to search types available to the user. The buttons 82-88 represent various conventional methods for searching for e-books. Upon display of the search menu on the screen 48, the user receives the search menu and its options and can review the search menu for purposes of choosing a desired type of search (S210).

After receiving and reviewing the search menu (such as menu 76), the user can enter search parameters and request a search be performed (S212). When search menu 76 is employed, the user would first select one of the search buttons 82-88 thereby selecting a search type. After entering a selection on the screen 48, a search parameters request is made by the printer 12. For example, a data entry field (not shown) could be displayed on the screen 48 corresponding to the search button 82-88 selected wherein the user could enter appropriate data (i.e., search parameters). In one embodiment, an interactive keyboard is displayed on the screen 48 enabling the user to enter data into the data entry field and the data entry field can employ a predefined mask that only allows the user to enter a limited amount of data. For example, if the ISDN button 82 is selected, then the displayed data entry field will only allow the user to enter numeric characters of a set length. Alternatively, if the one of the other buttons 84-88 are selected, then the displayed data entry field can be a free text area. Upon entering such data in the data entry field and/or upon selection of a search command or button, the printer 12 receives the entered search parameters and the search request (S214).

With the search parameters, the printer 12 performs a search (S216). More specifically, the printer 12 can search one of the remote databases 18,22,26 of electronic documents with or employing the search parameters previously entered by the user. In one embodiment, the search is performed by the printer 12 connecting to the network 14, which can be the Internet, and the printer 12 searches for all records corresponding to the entered search parameters in one or more specified databases of the networked databases 18,22,24, which are also connected to the network 14. Thus, through the network 14, the printer 12 is able to communicate with the remote databases 18,22,24 to search electronic documents contained thereon. The printer 12 could be configured to initially search only the first database 18 with the entered search parameters. If unavailable, the printer 12 could then move on to database 22 and/or database 24. Alternatively, the printer 12 can allow the user to specify the database or databases to be searched and in what order they should be searched. In such a printer 12, the user could be provided a list of databases and could receive a database selection or selections from the user of a databases or databases to be searched. The database selection made by the user would then correspond to which remote database (or databases) were to be searched with the search parameters. This could be accomplished through the touch screen 48. The databases 18,22,24 can be owned and operated by third party electronic document suppliers and/or the electronic documents contained therein can be e-books indexed for relatively fast searching.

After searching the remote database or databases 18,22,24, search results are generated from searched databases (S218). The search results can include one or more items corresponding to one or more of the electronic documents stored on the databases 18,22,24. More particularly, when searching the databases 18,22,24, the printer 12 can apply the entered search parameters to the electronic documents contained on the databases to yield the search results. In one embodiment, the printer 12 carries out indexed searches of the databases 18,22,24 and thus the search results are generated in a relatively short period of time, irrespective of the size of the databases. Once the search results have been generated, they are provided by the printer 12 to the user by displaying them on the screen 48 (S220).

After the search results are generated (S218) and displayed to the user (S220), the user receives the search results and can review the same (S222). As already described, the search results can include one or more items corresponding to electronic documents stored in the databases 18,22,24, the electronic documents being those that fit within the user provided search parameters. The user can then select one or more of the search result items to ultimately be printed by selecting or touching the appropriate area of the interactive touch screen 48 on the printer 12 (S224). Touching of the screen 48 to select items from the search results communicates the selected items to the printer, i.e., the printer 12 receives the selection of one or more items of the search results (S226).

In one embodiment, wherein the electronic documents are e-books, the search results returned are a list of available e-books that fit within the search parameters provided by the user. For example, with reference to FIG. 5, search results including a listing of e-books that could be displayed on screen 48 are shown and generally indicated by reference numeral 90. In the illustrated example, the search results include two items 92,94 relating to the same e-book available from two different suppliers 96,98 at two different costs 100,102. The user could then select one of the e-books listed, such as the one with the lower cost or one from a more preferred supplier in S224. Scrolling and related functions can be provided with the screen display 90, as shown. More particularly, in one embodiment, when the user selects an item from the search results, a new screen is shown on the display 48 corresponding to the selected item. The new screen could provide further details concerning the selected item, such as, for example, file size, document creation/modification data, copyright information, etc. Generally, the further details could include file properties and/or book attributes, and as will be described in more detail below, the further details could include payment information necessary for acquiring the selected item.

After receiving a selected item (S226), the printer 12 can request payment information from the user corresponding to the selected item by displaying the requested payment information on the screen 48 (S228). Upon display of the request for payment information, the user has received the request for payment information (S230). The user can then provide the requested payment information by entering the same into the interactive touch screen 48 (S232) so that the printer can receive the requested payment information from the user (S234). Once the payment information is received, the printer 12 can process the payment information (S236), i.e., verify that the provided payment information is correct and valid. After processing of the payment information, the printer 12 can download and print the electronic document corresponding to the selected item (S238). Specifically, the printer 12 can download the electronic document from the remote database on which the electronic document resides. Thereafter, the user can retrieve the printed document from the printer 12 (S240). Optionally, the printer 12 can save or store the downloaded selection on its memory 50 for future printing or processing.

In one embodiment, when the user selects an item from the search results (S224) intending to purchase, download and print the electronic document represented by the selected item, the printer 12 is routed to a payment website located on one of the network servers. Of course, the payment site can be hosted on a network server that is different from or the same as the network server on which the database having the desired electronic document is on or linked. The payment site can be displayed on the screen 48 and enable the user to enter appropriate payment information directly into the printer 12 for communication with the network server hosting the payment site. As is well known to those skilled in the art, the payment information can be transmitted from the printer 12 to the hosting server via a secure communication link. Payment information collected can include the user's address, desired delivery address, and other details commonly associated with purchasing an item over a network. Alternatively, the printer can be directly connected to a chip and pin unit which enables the user to swipe a credit or like card therethrough. The chip and pin unit collects information from the swiped card and communicates the collected information to an appropriate network server. Of course, as will appreciated by those skilled in the art, various other devices and means can be employed for collecting payment information from the user. If desired, a purchase confirmation display and/or printed sheet can be generated on or from the printer 12. Once payment information is process in S236, the electronic document can be downloaded and printed on the printer 12 as discussed above. Progress of the download and/or the printing can be displayed on the screen 48.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method for locally searching for and printing an electronic document on a local printer, comprising:
providing a search menu on a local printer;
receiving search parameters and a search request at said local printer from a user;
searching a remote database of electronic documents with said search parameters;
generating search results from said remote database, said search results comprising one or more items corresponding to one or more of said electronic documents;
providing said search results on said local printer;
receiving a selection of said one or more items of said search results at said local printer from said user; and
printing said selection on said local printer.

2. The method of claim 1 wherein providing a search menu on a local computer includes displaying said search menu on a display screen of said local printer and providing said search results includes displaying said search results on said display screen.

3. The method of claim 1 wherein said local computer includes a touch-screen display for providing said search menu, receiving said search parameters and said search request, providing said search results and receiving said selection.

4. The method of claim 1 further includes providing a function menu on said local printer and receiving a selected search function prior to providing said search menu on said local printer.

5. The method of claim 1 further including:
requesting payment information corresponding to said selection;
receiving said payment information at said local printer; and
processing said payment information prior to printing said selection on said local printer.

6. The method of claim 5 wherein receiving said payment information includes at least one of accepting said payment information inputted into an interactive touch-screen or accepting said payment information inputted into a chip and pin unit connected to said local printer.

7. The method of claim 1 wherein providing said search menu includes:
providing search types;
receiving a search type selection of said search types; and
providing a search parameters request corresponding to said search type selection.

8. The method of claim 7 wherein said search parameters correspond to said search type selection.

9. The method of claim 1 wherein searching a remote database includes:
communicating over a network with said remote database; and
applying said search parameters to said electronic documents in said remote database to yield said search results.

10. The method of claim 1 wherein said electronic documents are e-books.

11. The method of claim 1 further including downloading said selection from said remote database.

12. The method of claim 12 further including saving said selection on a memory of said local printer.

13. The method of claim 1 further including:
providing said user a list of provider databases; and
receiving a database selection from said list of provider databases, said database selection corresponding to said remote database searched with said search parameters.

14. A method for locally searching, selecting and printing one or more electronic documents on a local printer from a remote database, comprising:
entering search parameters on a local printer;
requesting a search of a remote database of electronic documents be preformed by said local printer employing said search parameters;
reviewing search results generated and displayed on said local printer, said search results comprising one or more items corresponding to said electronic documents;
selecting one of said one or more items on said local printer to be printed; and
retrieving printed copies of said selected one of said one or more items printed by said local printer from said local printer.

15. The method of claim 14 wherein said search parameters are entered on an interactive touch-screen of said local printer, said search is requested on said touch-screen, said search results are displayed on said touch screen and said selected on of said one or more items is made on said touch screen.

16. The method of claim 15 further including:
receiving a request for payment information on said local printer;
providing said payment information to said local printer prior to retrieving said printed copies of said selected one of said one or more items.

17. The method of claim 15 further including:
entering a search type into said local printer; and
entering search parameters into said local printer; said search parameters corresponding to said search type entered into said local printer.

18. A printing system for locally searching, selecting and printing one or more electronic documents on a local printer from a remote database, said printer system comprising:
a local printer having an input/output user interface that provides a search menu to a user, receives search parameters and a search request from said user, provides search results to said user, and receives a selection of one or more items from said search results; and
at least one remote network server having a database of electronic documents linked to said local printer over a network;
wherein said local printer searches said database of electronic documents using said search parameters to generate said search results of one or more items, said selection retrieved from said database and printed by said local printer.

19. The printing system of claim 18 wherein said input/output user interface is an interactive touch-screen.

20. The printing system of claim 18 wherein said local printer is a xerographic printer and includes:
a photoreceptive member for being uniformly charged across a portion thereof;
an imager connected to said electronic subsystem for selectively dissipating the charged portion of said photoreceptive member for recording a latent image corresponding to said print job;
a developer for developing a toner image on said photoreceptive member from said latent image;
a transfer station for transferring said toner image from said photoreceptive member to one of said plurality of print media sheets of said storage member; and
a fuser for permanently fixing or fusing said toner image to said one of said plurality of print media sheets.
